(19) United States
(12) Patent Application Publication
(10) Pub. No.: US 2005/0092656 A1
(43) Pub. Date: May 5, 2005

(54) Magnetic separator with electrostatic enhancement for fine dry particle separation

(76) Inventors: Eric Yan, Orange Park, FL (US); Bo R. Arvidson, Ponte Vedra Beach, FL (US)

Correspondence Address: Arthur G. Yeager, P.A., Suite 1, 245 East Adams Street, Jacksonville, FL, 32202-3336, US

(21) Appl. No.: 10/700,704

(22) Filed: Nov. 4, 2003

(51) Int. Cl. B04B 5/10

(52) U.S. Cl. 209/12.2; 209/218

(57) ABSTRACT

A magnetic separation system for separating magnetic from non-magnetic particles employing a dry drum/belt magnetic separator includes an electrostatic separator, including electrodes located closely adjacent a moving belt overlying the magnetic drum for attracting charged non-magnetic particles on the belt to remove such particles from the belt. The electrodes are formed as an elongate metal rod coated with a non-electrically conductive material. The rods are positioned lengthwise in a manner such that the rod is substantially transverse the direction of movement of the belt. The system also includes an ionizer for creating an ion cloud directed toward a surface of the belt for electrically neutralizing the surface of the belt.

### CROSS-REFERENCE TO RELATED APPLICATION

The present application is related to U.S. patent application Ser. No. 10/120,017 filed on Apr. 10, 2002, entitled “HIGH-TENSION ELECTROSTATIC CLASSIFIER AND SEPARATOR, AND ASSOCIATED METHOD”; and U.S. patent application Ser. No. 10/376,190 filed on Feb. 27, 2003, entitled “CORONA AND STATIC ELECTRODE ASSEMBLY”.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention relates to the use of electrostatic forces to enhance the operation of dry drum or belted roll magnetic separator.

2. Relevant Art

Magnet separation exploits the difference in magnetic properties between, for example, magnetic ore material and non-magnetic material. Magnet particles are pulled to the drum shell or belt surface by magnetic force from within the drum or roll. Non-magnetic material is thrown off by centrifugal force. The process works reasonably well for larger coarse particles because the centrifugal force is large enough to provide for adequate separation. What is needed is a process to adequately separate the non-magnetic fine particles that become electrically charged when such fine particles encounter a moving belt surface or drum shell beyond that which can be accomplished by the usual deionization devices.

### BRIEF SUMMARY OF THE INVENTION

In one aspect of the present invention there is provide in a magnetic separation system for separating magnetic from non-magnetic particles employing a dry belted roll magnetic separator, an electrostatic separator including at least one electrode located closely adjacent to a moving belt enveloping a magnetic roll drum for attracting charged non-magnetic particles on such a belt to remove such particles from such belt. Each electrode is formed as an elongate metal rod and is coated with a non-electrically conductive material. The rod is positioned lengthwise in a manner such that the rod is substantially transverse the direction of movement of such a belt. Each electrode carries a voltage potential for removing electrically charged non-magnetic particles from such belt.

In another aspect of the present invention there is provided in a magnetic separation system for separating magnetic from non-magnetic particles employing a dry drum/belt magnetic separator, an electrostatic device and an ionizer for separating electrically charged non-magnetic particles, the electrostatic device including a plurality of spaced elongated electrically charged electrodes for attracting such charged non-magnetic particles carried by such a belt, and an ionizer for creating an ion cloud directed toward a surface of such belt for electrically neutralizing such surface of such belt. The electrodes are located closely adjacent such belt. The electrodes are positioned lengthwise in a manner such that the electrodes are substantially transverse the direction of movement of such belt. Each electrode is an elongated metal rod. The electrodes are spaced vertically and carry a voltage potential for removing electrically charged non-magnetic particles from such a belt. The electrodes are positioned downstream of the ionizer with respect to the direction of motion of such belt, or below the ionizer.

In a further aspect of the present invention there is provided a magnetic separation system for separating magnetic from non-magnetic particles employing a dry belted roll separator, an electrostatic device and an ionizer for separating electrically charged non-magnetic particles on a moving belt from magnetic particles. The electrostatic device includes a plurality of spaced elongate electrically charged electrodes for attracting such charged non-magnetic particles carried by the belt, and an ionizer for creating an ion cloud directed toward a surface of the belt for electrically neutralizing such surface of the belt. The electrodes are located closely adjacent the belt and are positioned lengthwise in a manner such that the electrodes are substantially transverse the direction of movement of the belt. The electrodes are spaced vertically and are positioned upstream of the ionizer with respect to the direction of motion of the belt.

### BRIEF DESCRIPTION OF THE SEVERAL VIEWS OF THE DRAWING

The novel features which are believed to be characteristic of this invention are set forth with particularity in the appended claims. The invention itself, however, both as to its organization and method of operation, together with further objects and advantages thereof, may best be understood by reference to the following description, taken in connection with the accompanying drawings, in which:

FIG. 1 is a pictorial illustration of an enhanced magnetic separator in accord with the present invention;

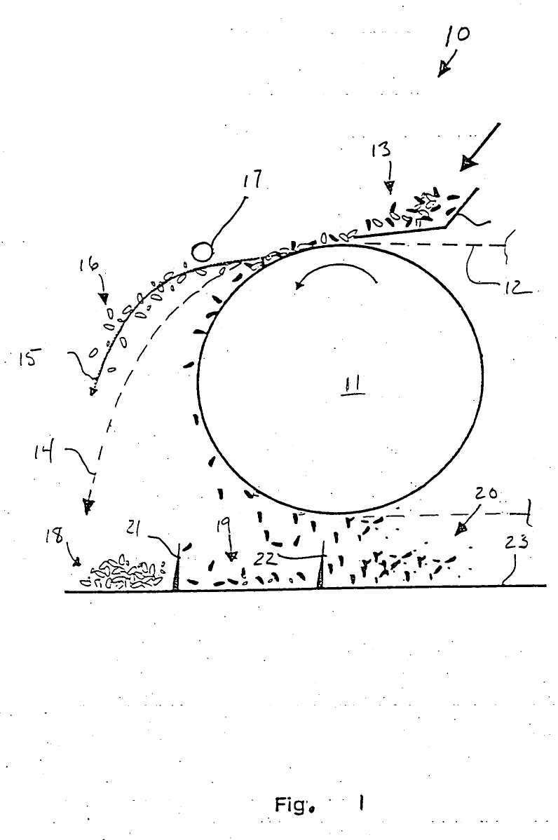

FIG. 2 is a partial pictorial illustration of another embodiment magnetic separator in accord with the present invention;

FIG. 3 is a pictorial illustration of another embodiment of a magnetic separator in accord with the present invention; and

FIG. 4 is a graph illustrating the forces employed in the embodiments of FIGS. 1-3.

### DETAILED DESCRIPTION OF THE INVENTION

Introduction

Magnetic separators exploit the difference in magnetic properties between the ore minerals and are used to separate magnetic minerals from non-magnetic. Over the years, provisions have been incorporated in the dry roll magnetic separator design to address the intensity of the magnetic field so as to deal with various types of material. However, the potential to improve the separator performance by reducing the fine non-magnetic particle misplacement has attracted less attention.

In the present invention an electrostatic technique is employed in conjunction with magnetic separation in an effort to minimize the amount of non-magnetic particles that adhere to the belt due to triboelectrification.

The magnetic particles are adhered to the drum/belt surface by the magnetic force generated by a magnetic roll while the non-magnetic particles are thrown away from the roll or belt by means of centrifugal force. For coarser particles, the magnitude of centrifugal force is sufficient enough to render a successful separation as Equation. 1 illustrates.
F_{c}=ma=4/3πr³ρωR²
where F_{c} is the centrifugal force, r is the radius of the particle, ρ the specific gravity of the particle, ω the angular velocity of the drum and R is the radius of the drum. Equation 1 suggests that for fine particle size, the centrifugal force is not sufficient enough to throw the fine particle from the drum surface, which leads to a misplacement of the non-magnetic particles in the magnetic particles compartment.

When ions generated by an ionizer are deposited on the surface of a particle the ions cannot migrate freely on the surface because the particle is non-conductive. Accordingly, the bonding force between the belt and particle cannot be neutralized effectively.

With the addition of high voltage static electrodes it has been found that non-magnetic particles can be lifted from the magnetic field and thus separated from the magnetic particles in a much-improved fashion. This process can be described with regard to Equation 2:

$$\begin{matrix}{F}_{E} = ma = qE \\ a = \frac{q}{m} E = \frac{3}{- 4} \frac{qE}{π {r}^{3} ρ}\end{matrix}$$

where F_{E} is the electrostatic force, a is the particle acceleration, q is the surface charge of particle, E the intensity of electric field, r the radius of particle, and ρ the specific density of particle. For fine particles, the charge to mass ratio is greater than that of coarse particles that helps fine particles move away from the drum surface with a higher acceleration. Fine non-magnetic particles, which lack sufficient mass to be thrown out of the drum, can benefit from the electrostatic attraction force to pull them away from the drum surface. In addition, the ionizer surface to inhibit future buildup of particles on the surface thereof.

One of the problems associated with dry magnetic separation is due to the fine particle size, e.g. below 20 um. The centrifugal force acting upon the fine particle is so low that even static charge and/or agglomeration force can prohibit the removal of fine particles from the process surface (belt or drum). Because of the high charge-to-mass ratio of the fine particles, the separation of these fine particles is strongly enhanced when an attracting strong electrostatic force is applied.

Table I gives the comparison result between the separation tests conducted with and without electrostatic addition. As shown, the middling portion of the separation was greatly reduced when electrostatic electrode was employed.

With respect to the drawings, a pictorial view of a enhanced magnetic separator in accord with the present invention is depicted at numeral 10. A magnetic separator drum 11 may be of the type described in U.S. Pat. No. 6,062,393 herein incorporated in its entirety or other dry drum/belt technology as understood in the art. Belt 12 is also a conventional belt as understood in the art. Feed 13 is directed onto belt 12. Non-magnetic particles 16 may follow one of two trajectories 14 and 15. Trajectory 14 is the one followed without the use of static electrode 17. The use of electrode 17 results in outwardly directed trajectory 15 as will be discussed hereinbelow. The trajectory 15 will provide for better separation of the materials into non-magnetic particles portion 18, middling portion 19, and magnetic particles 20 will be deposited on collection surface 23. Splitters 21 and 22 are as understood in the art.

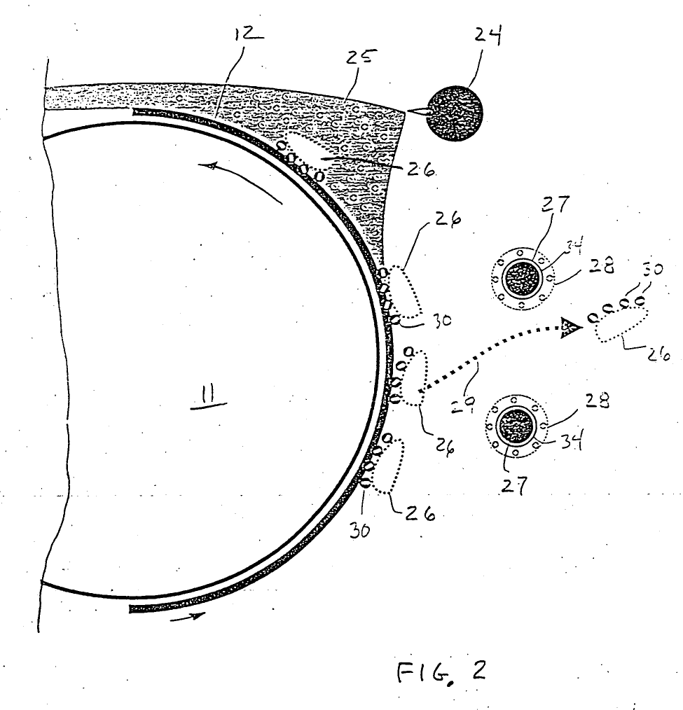

With respect to FIG. 2, a more detailed pictorial illustration of an embodiment of an enhanced separator of the present invention is depicted. Drum 11 and 12 are as before. In this arrangement ionizer 24 is provided to create ion cloud 25 directed towards belt 12.

Charged particles 26 are non-magnetic particles that have picked up an electric charge when they landed on belt 12. While the use of ionizer 24 helps in neutralizing the charge on belt 12, the use of static electrodes 27, located downstream or below the ionizer 24, creates an attractive force via field 28 and charge areas 30 for the removal of particles 26 from the belt. The trajectory 29 greatly assists in separation of non-magnetic fines 26 from the magnetic particles 20.

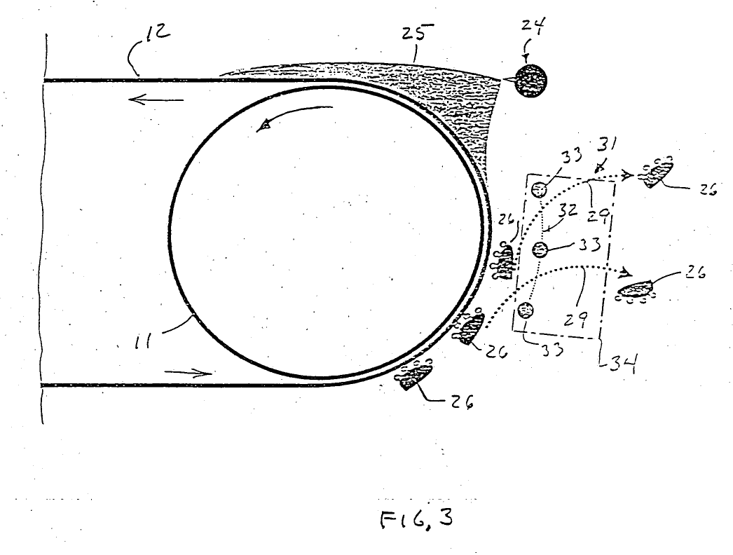

FIG. 3 illustrates another embodiment of the enhanced separator showing the electrodes 33 are arranged in a vertically oriented arcuate array 31 formed in an arc 32 that matches the curvature of the adjacent belt 12 and drum 11. Frame 34 is used to carry the electrodes as understood in the art.

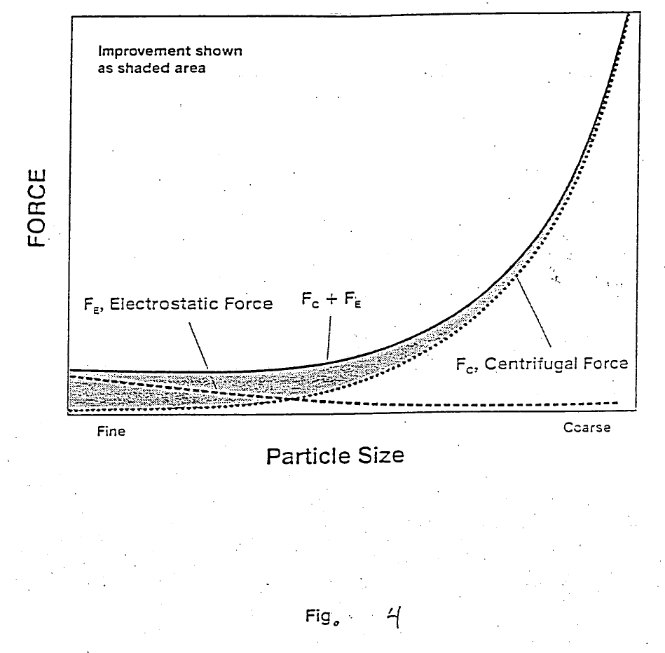

FIG. 4 illustrates the improvement in the separation of non-magnetic particles 26 with respect to size. Table 1 illustrates the recovery of the non-magnetic particles 26 which shows the improved efficiency achieved. Depending upon the desired separation the processed feed will be reprocessed again and again until the desired purity is attained.

Static electrodes 17, 27, 33 are of conventional design and structure as understood in the art of creating electrostatic fields. The number, size, and electric field magnitude of the electrodes employed will vary with the particular application using the technology. A non-conducting coating, such as coating 34 in FIG. 2, may be applied to any or all electrodes used in accordance with the present invention to inhibit arcing and enhance operator safety.

While the invention has been described with respect to certain specific embodiments, it will be appreciated that many modifications and changes may be made by those skilled in the art without departing from the spirit of the invention. It is intended therefore, by the appended claims to cover all such modifications and changes as fall within the true spirit and scope of the invention.

[image]

1. In a magnetic separation system for separating magnetic from non-magnetic particles employing a dry drum/belt magnetic separator, an electrostatic separator, said electrostatic separator including at least one electrode located closely adjacent a moving belt overlying a magnetic drum for attracting charged non-magnetic particles on such belt to remove such particles from such belt.

2. In the system as defined in claim 1 wherein said at least one electrode is formed as an elongate metal rod.

3. In the system as defined in claim 2 wherein said rod is coated with a non-electrically conductive material.

4. In the system as defined in claim 2 wherein said rod is positioned lengthwise in a manner such that said rod is substantially transverse the direction of movement of such belt.

5. In the system as defined in claim 1 wherein said at least one electrode carries a positive electric charge for removing negatively charged non-magnetic particles from such belt.

6. In a magnetic separation system for separating magnetic from non-magnetic particles employing a dry drum/belt magnetic separator, an electrostatic separator and an ionizer for separating electrically charged non-magnetic particles on a moving belt from magnetic particles, said electrostatic separator including a plurality of spaced elongate electrically charged electrodes for attracting such charged non-magnetic particles carried by such belt, and an ionizer for creating an ion cloud directed toward a surface of such belt for electrically neutralizing such surface of such belt.

7. In the system as defined in claim 6 wherein said electrodes are located closely adjacent such belt.

8. In the system as defined in claim 7 wherein said electrodes are positioned lengthwise in a manner such that said electrodes are substantially transverse the direction of movement of such belt.

9. In the system as defined in claim 6 wherein each said electrode is an elongate metal rod.

10. In the system as defined in claim 8 wherein said electrodes are spaced vertically.

11. In the system as defined in claim 6 wherein each electrode carries a positive electric charge for removing negatively charged non-magnetic particles from such belt.

12. In the system as defined in claim 6 wherein said electrodes are positioned downstream of said ionizer with respect to the direction of motion of such belt.

13. A magnetic separation system for separating magnetic from non-magnetic particles employing a dry drum/belt magnetic separator, an electrostatic separator said electrostatic separator including at least one electrode located closely adjacent moving said belt overlying said magnetic drum for attracting charged non-magnetic particles on said belt to remove such particles from said belt.

14. The system as defined in claim 13 wherein said at least one electrode is formed as an elongate metal rod.

15. The system as defined in claim 14 wherein said rod is positioned lengthwise in a manner such that said rod is substantially transverse the direction of movement of said belt.

16. A magnetic separation system for separating magnetic from non-magnetic particles employing a dry drum/belt magnetic separator, an electrostatic separator and an ionizer for separating electrically charged non-magnetic particles on a moving belt from magnetic particles, said electrostatic separator including a plurality of spaced elongate electrically charged electrodes for attracting such charged non-magnetic particles carried by said belt, and an ionizer for creating an ion cloud directed toward a surface of said belt for electrically neutralizing such surface of said belt.

17. The system as defined in claim 16 wherein said electrodes are located closely adjacent said belt.

18. The system as defined in claim 17 wherein said electrodes are positioned lengthwise in a manner such that said electrodes are substantially transverse the direction of movement of said belt.

19. The system as defined in claim 18 wherein said electrodes are spaced vertically.

20. The system as defined in claim 16 wherein said electrodes are positioned upstream of said ionizer with respect to the direction of motion of said belt.
